(19) United States
(12) Patent Application Publication
(10) Pub. No.: US 2011/0022956 A1
(43) Pub. Date: Jan. 27, 2011

(54) Chinese Character Input Device and Method Thereof

(75) Inventors: Ling-Fei Sung, Taipei (TW); Jui-Fang Chi, Taipei (TW); Ching-Hsiang Chiang, Taipei (TW)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: ASUSTEK COMPUTER INC., Taipei (TW)

(21) Appl. No.: 12/839,810

(22) Filed: Jul. 20, 2010

(30) Foreign Application Priority Data
Jul. 24, 2009 (TW) 98124971

(51) Int. Cl. G06F 3/048; G06F 3/01; G06F 3/041; G06F 17/30

(52) U.S. Cl. 715/702; 715/773; 345/173; 707/802; 707/E17.044

(57) ABSTRACT

A Chinese character input device and method thereof are described. The Chinese character input device includes a database, a touch panel and a processing module. The database stores multiple candidate characters, multiple initial consonants and multiple rhymes. Each candidate character is composed of at least one initial consonant and at least one rhyme. The touch panel displays a virtual keyboard including initial consonant virtual keys and rhyme virtual keys and receives a command. The command includes a touch on an initial consonant virtual key to determine an input initial consonant and a release at a rhyme virtual key to determine an input rhyme. The processing module is connected to the database and compares the input initial consonant and input rhyme with the initial consonants and rhymes in the database to generate at least one corresponding candidate character and displays the candidate character on the touch panel for selecting.

### CROSS-REFERENCES TO RELATED APPLICATIONS

This non-provisional application claims priority under 35 U.S.C. §119(a) on Patent Application No. 98124971 filed in Taiwan, R.O.C. on 2009/7/24, the entire contents of which are hereby incorporated by reference.

### BACKGROUND OF THE INVENTION

1. Field of the Invention

The invention relates to an input device and method and, more particularly, to a Chinese character input device and method thereof.

2. Description of the Related Art

Electronic devices, such as computers, mostly have multiple input interfaces such as keypads, mice, handwriting pads to allow a user input commands or characters to make the electronic device perform the corresponding operations. With the development of science and technology, the input interface of the electronic device is more and more human oriented, and the touch inputting becomes to be the popular Chinese input manner due to its intuitive and convenient characters.

When the electronic device has a touch panel, the user may input the commands by touching the touch panel with a finger or a stylus. Since the intuitive input method is popular to more and more users, the touch input method has been more and more preferred by manufacturers and consumers.

However, to an electronic device with the Chinese character input function, it is inconvenient to input the Chinese character via the touch panel that replaces the conventional keyboard. For example, when Chinese characters are input in the conventional touch panel, if using a phonetic spelling input method, the touch panel may display a virtual keyboard, and each virtual key in the virtual keyboard has a phonetic symbol for being touched and selected to spell a Chinese character. However, each phonetic notation of the Chinese character is composed of an initial consonant, a head vowel, a rhyme and tone. That is, when inputting a Chinese character, the user needs to select the initial consonant, the head vowel, the rhyme, and the tone to spell the character. For example, to input the character [symbol] the user needs to orderly click the initial consonant [symbol] the head vowel [symbol] the rhyme [symbol] and the tone “ ” to input the character. Since the single character is complex in clicking and selecting, when the user wants to input a whole text, he or she may feel rather inconvenience.

### BRIEF SUMMARY OF THE INVENTION

The invention discloses a Chinese character input device using a touch panel to input Chinese characters. The Chinese character input device includes a database, a touch panel being able to display a virtual keyboard and a processing module. The database may be an electronic device and stores multiple candidate characters, multiple initial consonants and multiple rhymes. Each candidate character is composed of at least one initial consonant and at least one rhyme. The touch panel displays the virtual keyboard at least including initial consonant virtual keys and rhyme virtual keys and receives commands. A command includes a touch on the initial consonant virtual key of the virtual keyboard to determine an input initial consonant, and a dragging and stay over the initial consonant virtual key and a release at the rhyme virtual key of the virtual keyboard to determine an input rhyme. The processing module is connected to the database and receives the command, and it compares the input initial consonant and the input rhyme with the initial consonants and the rhymes in the database to generate at least one corresponding candidate character, and then the candidate character is displayed on the touch panel for selecting.

The invention also discloses a Chinese character input device using the touch panel to input Chinese characters. The Chinese character input device includes a database, a touch panel being able to display a virtual keyboard and a processing module. The database stores multiple candidate characters, multiple initial consonants, multiple head vowels and multiple rhymes. Each candidate character is composed of at least one initial consonant, at least one head vowel and at least one rhyme. The touch panel displays the virtual keyboard at least displays initial consonant virtual keys, head vowel virtual keys and rhyme virtual keys on the touch panel and receives commands. A command includes a touch on the initial consonant virtual key of the virtual keyboard to determine an input initial consonant, a drag and stay over the head vowel virtual key of the virtual keyboard to determine a head vowel and a release at the rhyme virtual key of the virtual keyboard to determine the input rhyme. The processing module is connected to the database and receives the command, and it compares the input initial consonant, the input head vowel and the input rhyme with the initial consonants, the head vowels and the rhymes to generate at least one corresponding candidate character, and then the candidate character is displayed on the touch panel for selecting.

The invention also discloses a Chinese character input method using a touch panel to input Chinese characters. The Chinese character input device stores multiple candidate characters, multiple initial consonants and multiple rhymes in a database, wherein each candidate character is composed of at least one initial consonant and at least one rhyme, the Chinese character input method includes the steps as follows: Displaying initial consonant virtual keys and rhyme virtual keys on the touch panel; Receiving a command by the touch panel, wherein the command includes a touch on the initial consonant virtual key of the virtual keyboard to determine an input initial consonant, a release at the rhyme virtual key of the virtual keyboard to determine the input rhyme; Comparing the input initial consonant and the input rhyme with the initial consonant and the rhyme stored in the database to generate at least one corresponding candidate character; and Displaying the candidate character on the touch panel for selecting.

The invention also discloses a Chinese character input method using a touch panel to input Chinese characters. The Chinese character input device stores multiple candidate characters, multiple initial consonants, multiple head vowels and multiple rhymes in a database, wherein each candidate character is composed of at least one initial consonant, at least one head vowel and at least one rhyme, the Chinese character input method includes the steps as follows. Displaying the initial consonant virtual keys, the head vowel virtual keys and the rhyme virtual keys on the touch panel. Receiving a command by the touch panel, wherein the command includes a touch on the initial consonant virtual key of the virtual keyboard to determine the input initial consonant, a drag and stay over the head vowel virtual key of the virtual keyboard to determine the input head vowel and a release at the rhyme virtual key of the virtual keyboard to determine the input rhyme. Comparing the input initial consonant, the input head vowel and the input rhyme with the initial consonants, the head vowels and the rhymes in the database to generate at least one corresponding candidate character, and displaying the candidate character on the touch panel for selecting.

With the Chinese character input device or method in the invention, each Chinese character is determined rapidly by only one touch-drag-release movement that applying on the touch panel. Therefore, tedious and time-consuming clicking of icons on the touch panel is saved, and thus the speed of inputting Chinese characters is greatly improved. With such, the user may input Chinese characters more conveniently.

These and other features, aspects and advantages of the present invention will become better understood with regard to the following description, appended claims, and accompanying drawings.

### BRIEF DESCRIPTION OF THE DRAWINGS

FIG. 1 is a block diagram showing the Chinese character input device in an embodiment of the invention;

FIG. 2A is a first schematic diagram showing the application of the Chinese character input device in the first embodiment of the invention;

FIG. 2B is a second schematic diagram showing the application of the Chinese character input device in the second embodiment of the invention;

FIG. 3A is a first schematic diagram showing the Chinese character input device in the second embodiment of the invention;

FIG. 3B is a second schematic diagram showing the Chinese character input device in the second embodiment of the invention;

FIG. 4 is a flow chart diagram showing the Chinese character input method in the first embodiment of the invention; and

FIG. 5 is a flow chart showing the Chinese character input method in the second embodiment of the invention.

### DETAILED DESCRIPTION OF THE EMBODIMENTS

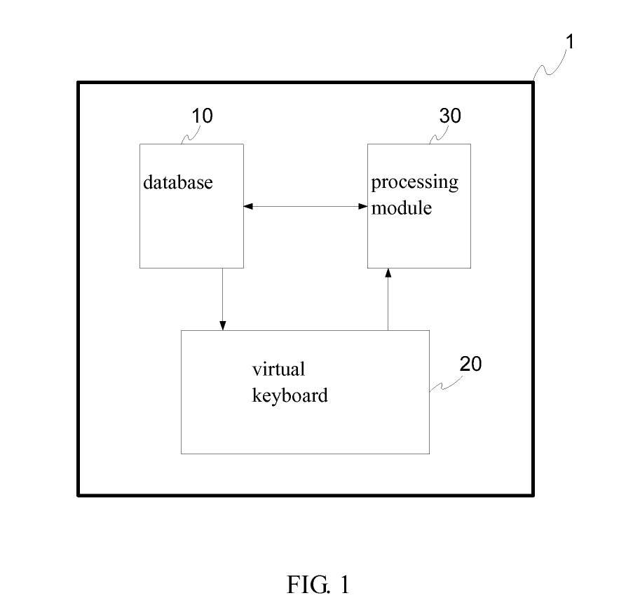

FIG. 1 is a block diagram showing the Chinese character input device in an embodiment of the invention. The Chinese character input device includes a database 10, a touch panel 1 being able to display a virtual keyboard 20, and a processing module 30.

The database 10 stores multiple candidate characters, multiple initial consonants and multiple rhymes. Each candidate character is composed of an initial consonant and a rhyme. Since the Chinese character input device in accordance with present invention is adapted to input Chinese characters, said candidate characters are Chinese characters. Each candidate character has a corresponding Chinese phonetic notation, and the phonetic notation usually includes an initial consonant, a head vowel, a vowel and tone. To simplify the input processes, the invention discloses an inputting method in which only initial consonant and vowel needs to be input to complete the input process (this is illustrated herein below), and thus each candidate character at least composed of the corresponding initial consonant and the corresponding rhyme.

The virtual keyboard 20 displayed on the touch panel 1 at least includes multiple initial consonant virtual keys and multiple rhyme virtual keys. That is, the touch panel 1 may display the virtual keyboard 20, and each key in the virtual keyboard 20 denotes an initial consonant or a rhyme by presenting Chinese phonetic symbols respectively. The virtual keyboard 20 also may further include head vowel virtual keys, tone or other virtual keys such as English letters or numbers, and the invention is not limited thereto.

The user may input a commands via pressing the virtual keyboard 20 displayed on the touch panel 1. The command received by the virtual keyboard 20 includes a touch on the initial consonant virtual key to determine an input initial consonant, and a release at the rhyme virtual key of the virtual keyboard 20 to determine an input rhyme. For example, the user may input the command as following description. When one of multiple initial consonant virtual keys is touched, an input initial consonant is determined. Then, drag the finger from the input initial consonant virtual key to one of the rhymes and released, an input rhyme is determined therewith. That is the whole input process.

The processing module 30 is connected to the database 10. After receives the command, the processing module 30 compares the input initial consonant and input rhyme with the initial consonants, the rhymes that stored in the database 10, so as to find out one corresponding initial consonant and rhyme and generate at least one corresponding candidate character. The candidate character is displayed on the touch panel 1 for selection by the user. Simply saying, the processing module 30 may receive the command and produce a candidate character according solely to a touching and releasing position.

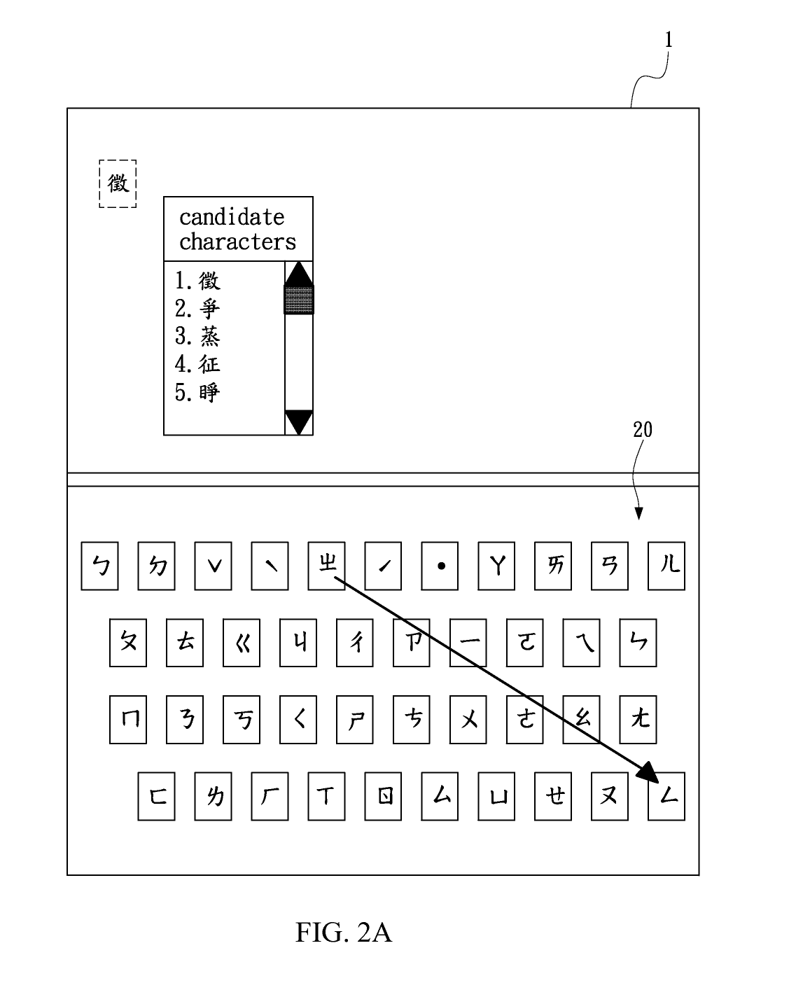

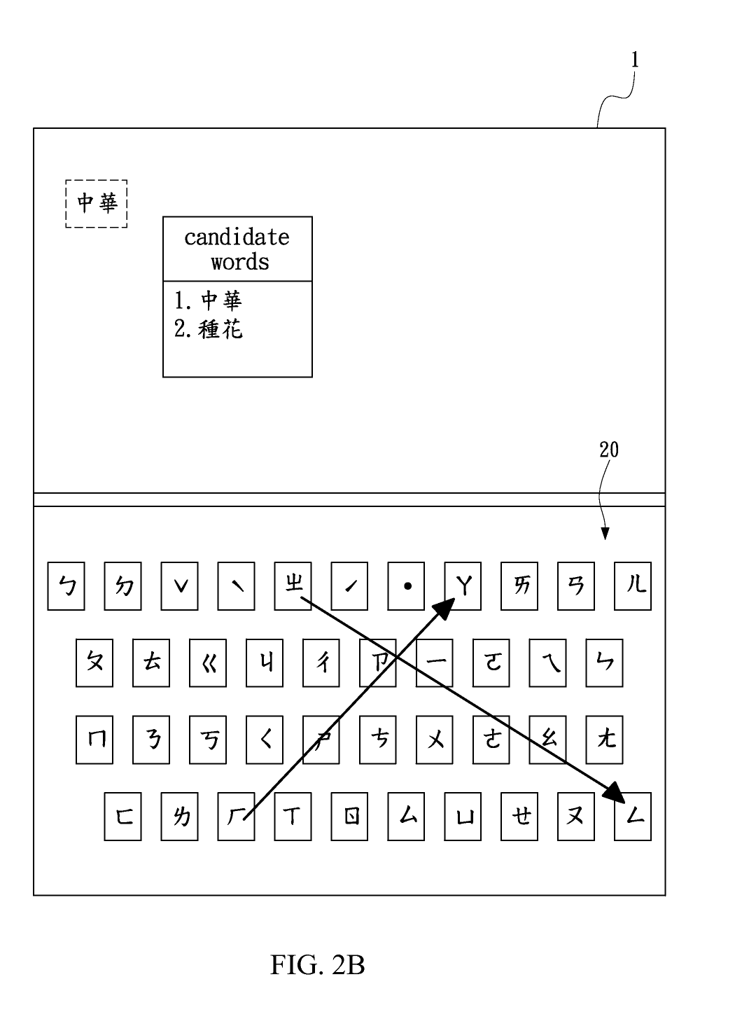

FIG. 2A is a first schematic diagram showing the application of the Chinese character input device in the first embodiment of the invention. As shown in the virtual keyboard 20 displayed on the touch panel 1, just as a standard keyboard, the virtual keyboard displays all the Chinese phonetic notations including initial consonant virtual keys, head vowel virtual keys and rhyme virtual keys. If the user wants to input the Chinese character [symbol] when the conventional touch input method is used, he or she may orderly select the initial consonant [symbol] the head vowel [symbol] the rhyme [symbol] and the first tone to input the character. However, with present invention, the user only needs to press the initial consonant virtual key [symbol] which is determined as the input initial consonant. Then, the user drags his/her finger from the initial consonant virtual key [symbol] to the rhyme virtual key [symbol] and releases at the rhyme virtual key [symbol] then the rhyme [symbol] becomes the input rhyme. Therefore, only one touch, drag and release is needed for completing the input process, which is more convenient and time-saving. Afterward, the touch panel 1 displays all the candidate characters composed of the initial consonant and rhyme that corresponding to the input initial consonant and the input rhyme, and that is, all the candidate characters beginning with [symbol] and ending with [symbol] [symbol] [symbol] [symbol] [symbol] [symbol] and [symbol] are displayed on the touch panel 1 and allows the user to select.

In addition, besides multiple candidate characters, the database 10 also may store multiple candidate words, may also be terms or sentences, and each candidate words includes at least two candidate characters.

FIG. 2B is a second schematic diagram showing the application of the Chinese character input device in the second embodiment of the invention. When the processing module 30 continuously receive multiple commands, it retrieves the candidate words composed of the candidate characters corresponding to the commands from the database, and displays the candidate words on the touch panel 1 for selection. As shown in FIG. 2B, if the user wants to input the word [symbol] he or she inputs the initial consonant [symbol] and vowel [symbol] via the above mentioned method. When the touch panel 1 displays multiple corresponding candidate characters after the first input process, he or she may continuously input the next character [symbol] instead of selecting one from the candidate characters displayed. Said command for inputting the next character [symbol] includes a touch on the initial consonant virtual key [symbol] and a dragging from the initial consonant virtual key [symbol] to the rhyme virtual key [symbol] and a release at the rhyme virtual key [symbol] .

In the embodiment, with multiple commands are input continuously, all the candidate characters composed of the initial consonants and rhymes that corresponding to the input initial consonants and the input rhymes are searched in the database 10. Then, all the candidate characters searched out are combined for comparing with candidate words stored in the database 10, such that corresponding candidate words are retrieved and displayed for selection. As shown in FIG. 2B, at last, two candidate words [symbol] and [symbol] are displayed, and the user may selects predetermined word [symbol] . Consequently, the input steps are simplified, and the input is fast and time-saving.

In addition, to have more preciseness and save time in selecting the Chinese character from the candidate characters, the command may further include an input of the head vowel. Within such manner, the command includes a touch on the initial consonant virtual key in the virtual keyboard 20 to determine the input initial consonant, a drag and stay over the head vowel virtual key of the virtual keyboard 20 to determine the input head vowel, and a release at the rhyme virtual key of the virtual keyboard 20 to determine the input rhyme.

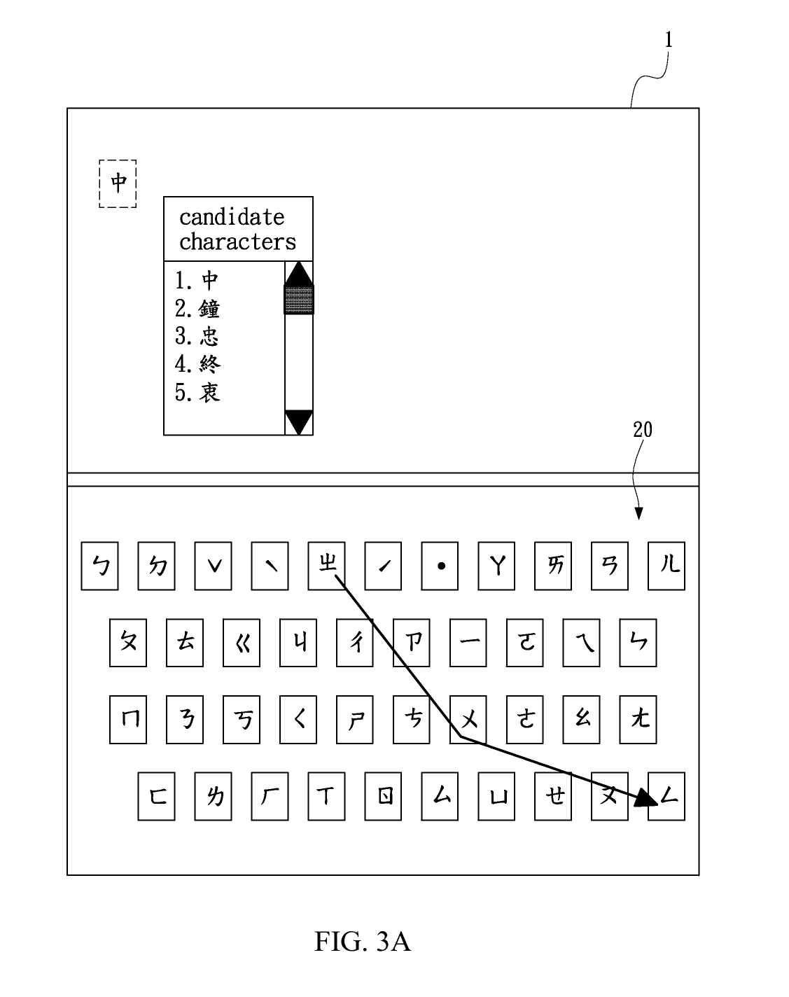

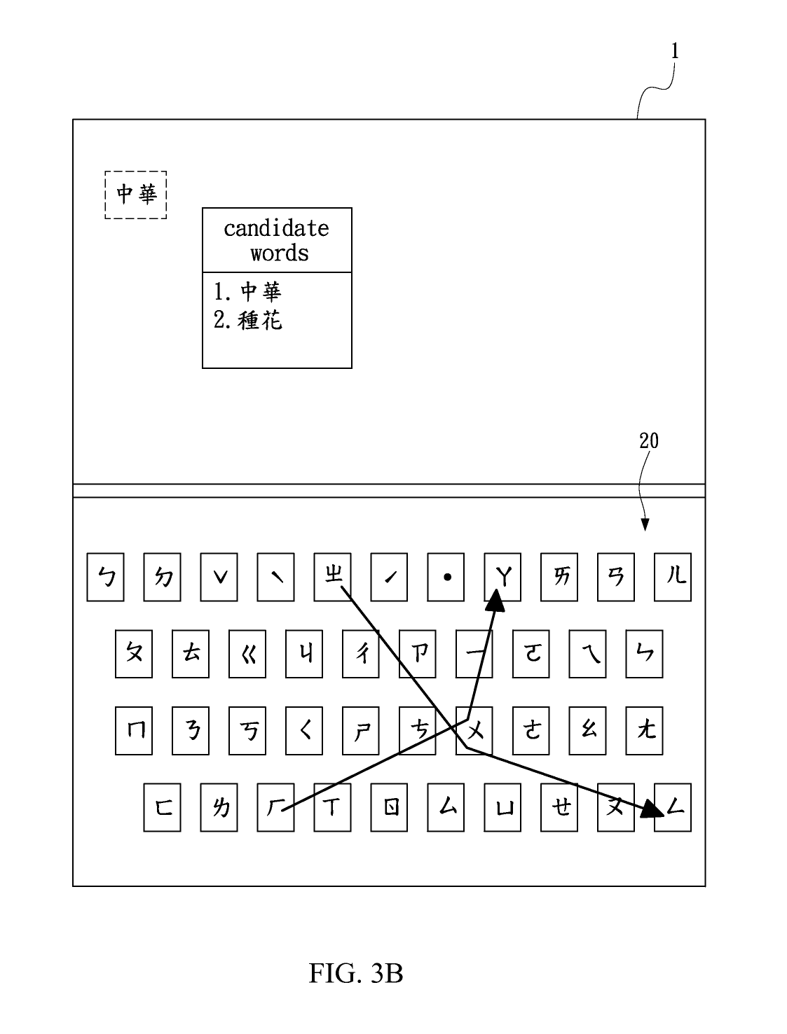

FIG. 3A is a first schematic diagram showing the Chinese character input device in the second embodiment of the invention. In the embodiment, to input the character [symbol] the command includes a touch on the initial consonant virtual key [symbol] to determine the [symbol] as the input initial consonant, a drag from the initial consonant virtual key [symbol] to the head vowel virtual key [symbol] and stay for a while to make the processing module 30 determine the [symbol] as the input head vowel, and a release at the rhyme virtual key [symbol] to make the rhyme virtual key [symbol] be determined as the input rhyme. Similarly, only one touch is needed when the input process is performed. Different from the first embodiment, the second embodiment further has the step of staying at the head vowel virtual key. At that moment, the touch panel 1 displays all candidate characters composed of the initial consonants, head vowels and rhymes that corresponding to the input initial consonant, the input head vowel and the input rhyme, namely the candidate character list including the [symbol] [symbol] and [symbol] to allow the user to select characters. Therefore, the candidate character list may be more accurate due to the head vowel, and the time in selecting the candidate characters is reduced.

In the embodiment, the database 10 stores multiple candidate characters, and it also stores candidate words composed of at least two candidate characters. As shown in FIG. 3B, it is a second schematic diagram showing the Chinese character input device in the second embodiment of the invention. As shown in FIG. 3B, if the user wants to input the word [symbol] he or she inputs the initial consonant [symbol] the head vowel [symbol] and the rhyme [symbol] via the above method.

When the touch panel 1 displays multiple corresponding candidate characters after the first input process, he or she may continuously input the next character [symbol] instead of selecting one from the candidate characters displayed

Said command for inputting the next character [symbol] includes a touch on the initial consonant virtual key [symbol] a dragging over the head vowel virtual key [symbol] and a release at the rhyme virtual key [symbol] . Such, the user only needs to touch once, and further stay at the head vowel virtual key.

Similarly, the processing module 30 may search all the candidate characters composed of the initial consonants, head vowels and rhymes that corresponding to the input rhymes, the input head vowels and the input initial consonants that input in two touch-drag-release movement, and then it pairs all the candidate characters and compares them with the candidate words stored in the database 10. Finally, the matched words are selected and displayed. Since the initial consonant, the head vowel and the rhyme are input, the corresponding candidate characters are more accurate, the time spent in the selecting and calculation is reduced, and the efficient is improved. As shown in FIG. 3B, the final displayed candidate words are [symbol] and [symbol] and the user selects [symbol] to complete the input.

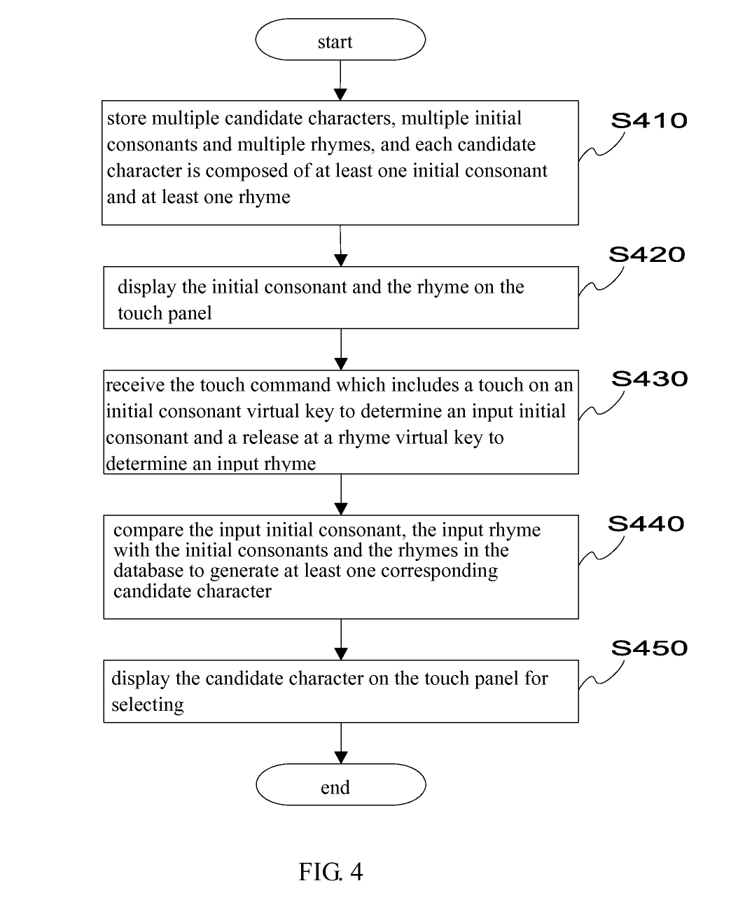

As shown in FIG. 4, it is a flow chart diagram showing the Chinese character input method in the first embodiment of the invention. The Chinese character input method using the touch panel to input the Chinese includes the following steps.

At step S410, multiple candidate characters, multiple initial consonants and multiple rhymes are stored in a database. Each candidate character is composed of at least one initial consonant and at least one rhyme.

At step S420, a virtual keyboard including initial consonant virtual keys and rhyme virtual keys are displayed on the touch panel.

At step S430, the command are received, and the command includes a touch on the initial consonant virtual key of the virtual keyboard that determines the input initial consonant, and a release at the rhyme virtual key to determine the input rhyme.

At step S440, the input initial consonant and the input rhyme are compared with the initial consonants and the rhymes in the database to generate at least one corresponding candidate character.

At step S450, the candidate characters are displayed on the touch panel for selecting.

In addition, in step S410, multiple candidate words further are stored in a database, and each candidate word is composed of at least two candidate characters. When multiple commands are received continuously in step S430, the Chinese character input method may further include retrieving the candidate words composed of the candidate characters corresponding to the commands, and displaying the candidate words on the touch panel for selecting.

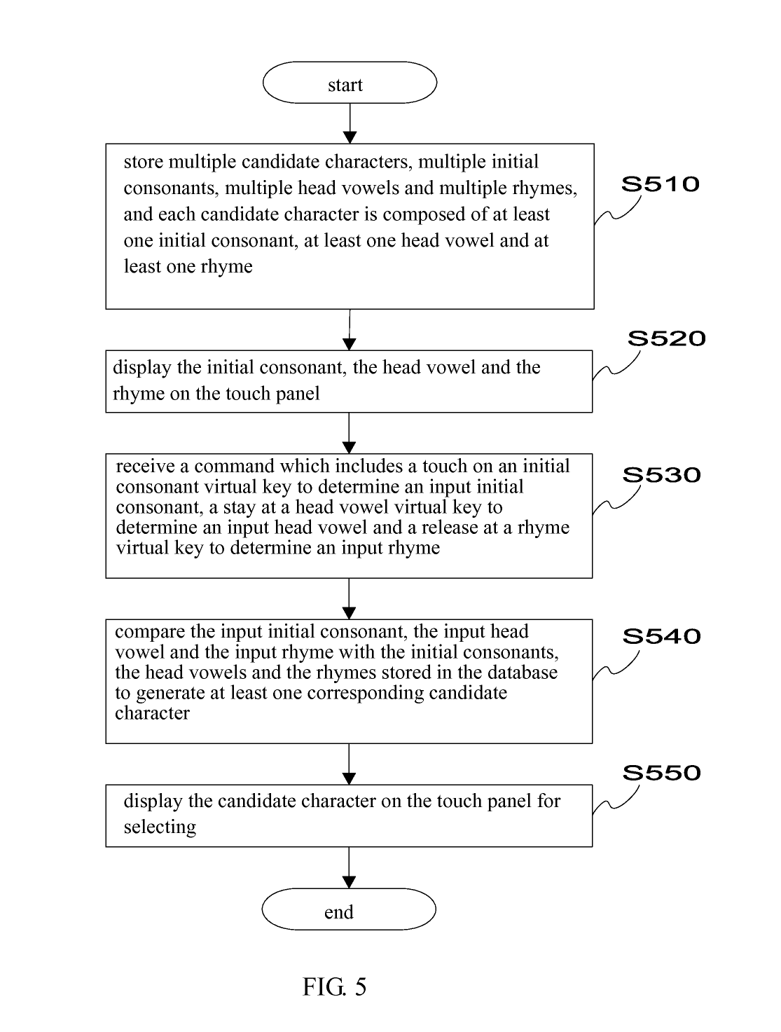

As shown in FIG. 5, it is a flow chart showing the Chinese character input method in the second embodiment of the invention. The Chinese character input method using the touch panel includes the steps as follows.

At step S510, multiple candidate characters multiple initial consonants multiple head vowels and multiple rhymes are stored, and each candidate character is composed of at least one initial consonant, at least one head vowel and at least one rhyme.

At step S520, a virtual keyboard including initial consonant virtual keys, the head vowel virtual keys and the rhyme virtual keys are displayed on the touch panel.

At step S530, the command is received, and the command includes a touch on the initial consonant virtual keys of the virtual keyboard to determine the input initial consonant, a drag and stay over the head vowel virtual keys of the virtual keyboard for a while that determines the input head vowel and a release at the rhyme virtual keys of the virtual keyboard to determine the input rhyme.

At step S540, the input initial consonant, the input head vowel and the input rhyme are compared with the initial consonants, the head vowels and the rhymes in the database to generate at least one corresponding candidate character.

At step S550, the candidate characters are displayed on the touch panel for selecting.

In addition, in step S510, multiple candidate words may further be stored in a database, and each candidate word is composed of at least two candidate characters. When multiple commands are received continuously in step S530, the Chinese character input method may further include retrieving the candidate word composed of the candidate characters corresponding to the commands, and displaying the candidate word on the touch panel for selecting.

The different between the methods in FIG. 4 and FIG. 5 is that the command in FIG. 5 includes the input of the head vowel, and thus the corresponding candidate characters are more accurate, and the user may complete the input more efficiently.

Although the present invention has been described in considerable detail with reference to certain preferred embodiments thereof, the disclosure is not for limiting the scope of the invention. Persons having ordinary skill in the art may make various modifications and changes without departing from the scope. Therefore, the scope of the appended claims should not be limited to the description of the preferred embodiments described above.

What is claimed is:

1. A Chinese character input device comprising:
a database storing multiple candidate characters, multiple initial consonants and multiple rhymes, wherein the candidate character is composed of at least one initial consonant and at least one rhyme;
a touch panel displaying a virtual keyboard and determining an input rhyme and an input initial consonant when receiving a command that comprise a touch and a release of the virtual keyboard; and
a processing module connected to the database and comparing the input rhyme, the input initial consonant with the initial consonants and the rhymes stored in the database, thereby generating at least one corresponding candidate character and displaying the candidate characters on the touch panel for selecting.

2. The Chinese character input device according to claim 1, wherein the virtual keyboard at least comprises multiple initial consonant virtual keys and multiple rhyme virtual keys, and the command comprises a touch on one of the initial consonant virtual keys of the virtual keyboard to determine the input initial consonant, and a release at one of the rhyme virtual keys to determine the input rhyme.

3. The Chinese character input device according to claim 1, wherein the database further stores multiple candidate words, and each of the candidate words is composed of at least two candidate characters.

4. The Chinese character input device according to claim 3, wherein when the processing module receives multiple commands continuously, the database retrieves at least one candidate word composed of candidate characters corresponding to the commands, and the touch panel displays the at least one candidate word for selecting.

5. The Chinese character input device according to claim 1, wherein the database further stores multiple head vowels, and the touch panel further determines an input head vowel when the command is received, and the processing module further compares the input head vowel with the head vowels stored in the database to generate the at least one corresponding candidate character.

6. The Chinese character input device according to claim 5, wherein the virtual keyboard at least comprises multiple initial consonant virtual keys, multiple rhyme virtual keys and multiple head vowel virtual keys.

7. The Chinese character input device according to claim 6, wherein the command comprises a touch on one of the initial consonant virtual keys to determine the input initial consonant, a drag and a stay over one of the head vowel virtual keys to determine the input head vowel, and a release at one of the rhyme virtual keys to determine the input rhyme.

8. A Chinese character input method cooperating with an electronic device with a touch panel, wherein the electronic device stores multiple initial consonants, multiple rhymes and multiple candidate characters being composed of at least one initial consonant and at least one rhyme, and the touch panel displays a virtual keyboard with initial consonant virtual keys and rhyme virtual keys, the Chinese character input method comprising the steps of:
receiving a command that comprise a touch and a release of the virtual keyboard and determining an input initial consonant and an input rhyme; and
comparing the input initial consonant and the input rhyme with the initial consonants and the rhymes stored in the electronic device to generate at least one corresponding candidate character, and
displaying the corresponding candidate character on the touch panel for selecting.

9. The Chinese character input method according to claim 8, wherein the command comprises a touch on one of the initial consonant virtual keys of the virtual keyboard to determine the input initial consonant, and a release at one of the rhyme virtual keys of the virtual keyboard to determine the input rhyme.

10. The Chinese character input method according to claim 8, further comprising:
storing multiple candidate words in the electronic device, wherein each of the candidate words is composed of at least two candidate characters.

11. The Chinese character input method according to claim 10, wherein when multiple commands are received continuously, the Chinese character input method further comprises the step of:
retrieving at least one candidate word composed of candidate characters corresponding to the commands; and
displaying the candidate words on the touch panel for selecting.

12. A Chinese character input method cooperating with an electronic device having a touch panel, wherein the electronic device stores multiple initial consonants, multiple head vowels, multiple rhymes and multiple candidate characters being composed of at least one initial consonant, head vowel and rhyme, the touch panel displays a virtual keyboard with multiple initial consonant virtual keys, multiple head vowel virtual keys and multiple rhyme virtual keys, the Chinese character input method comprising steps of:
receiving a command that comprise a touch, a stay and a release of the virtual keyboard and determining an input initial consonant, an input head vowel and an input rhyme; and
comparing the input initial consonant, the input head vowel and the input rhyme with the initial consonants, the head vowels and the rhymes stored in the electronic device; and
displaying the candidate character composed of the initial consonant, head vowel and rhyme that corresponding to the input initial consonant, the input head vowel and the input rhyme on the touch panel for selecting.

13. The Chinese character input method according to claim 12, wherein the command comprises a touch on one of the initial consonant virtual keys of the virtual keyboard to determine the input initial consonant, a drag and stay over one of the head vowel virtual keys of the virtual keyboard to determine the input head vowel, and a release at one of the rhyme virtual keys of the virtual keyboard to determine the input rhyme.

14. The Chinese character input method according to claim 12, further comprising:
storing multiple candidate words in the electronic device, wherein each of the candidate words is composed of at least two candidate characters.

15. The Chinese character input method according to claim 12, wherein when multiple commands are received continuously, the Chinese character input method further comprises the step of:
retrieving the candidate words composed of candidate characters corresponding to the commands; and
displaying the candidate words on the touch panel for selecting.
